(19) United States
(12) Patent Application Publication
(10) Pub. No.: US 2005/0117891 A1
(43) Pub. Date: Jun. 2, 2005

(54) Audio/video reproduction apparatus

(75) Inventor: Nobuyuki Suzuki, Fuchu-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/995,541

(22) Filed: Nov. 24, 2004

(30) Foreign Application Priority Data
Nov. 28, 2003 (JP) 2003-400887

(51) Int. Cl. H04N 5/781

(52) U.S. Cl. 386/96; 386/125

(57) ABSTRACT

An audio/video reproduction apparatus is disclosed. A stream separating unit, upon detection of the discontinuity of time stamps between a preceding VOBU and a succeeding VOBU midway of an MPEG stream read from a medium, stops writing the data in elementary buffers until the complete reproduction of the preceding VOBU stored in the elementary buffers by elementary decoders. At the end of the reproduction of the preceding VOBU, the stream separation unit changes the value of the system clock STC, while at the same time restarting the operation of writing the data of and subsequent to the succeeding VOBU in each elementary buffer.

### CROSS-REFERENCE TO RELATED APPLICATIONS

This application is based upon and claims the benefit of priority from prior Japanese Patent Application No. 2003-400887, filed Nov. 28, 2003, the entire contents of which are incorporated herein by reference.

### BACKGROUND OF THE INVENTION

1. Field of the Invention

The present invention relates to an audio/video reproduction apparatus for an MPEG stream (MPEG2 program stream, MPEG1 system stream) including compressed audio/video information.

2. Description of the Related Art

In the MPEG stream, each of audio and video data is contained in a pack having a predetermined amount of data. Each pack includes a pack header and a packet which in turn includes a packet header and compressed audio or video data. The packet header has time stamps such as PTS (presentation time stamp) or DTS (decoding time stamp). The DTS is time data indicating the timing of decoding the compressed data in the packet, and the PTS is time data indicating the timing of displaying the decoded data. The compressed data in the packet are decoded at the timing indicated by the DTS and displayed at the timing indicated by the PTS.

The discontinuity of the time stamps is caused by editing the MPEG stream by cutting, for example, a middle part thereof. In the case where this stream is reproduced as it is, the image and the sound are generally reproduced out of synchronism with each other. In editing the stream, therefore, the configuration at the stream connection point is processed in such a manner that the image and the sound may be reproduced in synchronism with each other. The continuous reproduction of a stream having discontinuous time stamps described above with the image and the sound in synchronism with each other is called the seamless reproduction. The seamless reproduction method is described in detail in “DVD Specifications for Read-Only Disc Part 3/Video Specifications (distributed by Kabushiki Kaisha Toshiba)”.

In the case where a discontinuity of the time stamps occurred midway of a stream for which the seamless connection is not guaranteed (the stream connection point has no configuration processed as described above), the difference of the reproduction time between the audio and video signals generates an audio gap or a video gap making it impossible to synchronize the audio and video signals. In this case, the clock of the system (STC) is required to be reset, thereby stopping both the image and the sound for a while.

### BRIEF SUMMARY OF THE INVENTION

According to an aspect of the present invention, there is provided An audio/video reproduction apparatus comprising: a stream separation unit which separates a video stream and an audio stream from an MPEG stream read from a medium; a first storage unit which stores the video stream separated by the stream separation unit; a second storage unit which stores the audio stream separated by the stream separation unit; a clock unit which provides the reference time of operation; a video decoder which reads the video stream stored in the first storage unit and reproduces by decoding the video stream based on the value on the clock unit; and an audio decoder which reads the audio stream stored in the second storage unit and reproduces by decoding the audio stream based on the value on the clock unit, wherein the stream separation unit comprises: a determining unit which determines the continuity of time stamps between a preceding VOBU (video object unit) and a succeeding VOBU midway of the MPEG stream read; a stop unit which stops the operation of writing the data in the first and second storage units until the end of reproduction of the preceding VOBU stored in the first and second storage units by the video decoder and the audio decoder in the case where the discontinuity of the time stamps is detected by the determining means; a change unit which changes the value on the clock unit; and a restart unit which restarts the operation of writing the data including and subsequent to the succeeding VOBU in the first and second storage units upon completion of reproduction of the preceding VOBU.

In reproducing a discontinuous stream for which the seamless reproduction is not guaranteed, the period during which the reproduction of the image and the sound is stopped is shortened as far as possible and the discontinuous stream can be reproduced in pseudo-seamless way.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a system according to the invention;

FIG. 2 is a diagram showing a physical structure of DVD-video;

FIG. 3 is a diagram showing an example of a configuration of a program stream;

FIG. 4 is a diagram showing stream_id of the DVD-video;

FIG. 5 is a diagram showing the pack structure of the DVD-video;

FIG. 6 is a flowchart showing the stream reproduction of a stream separation unit;

FIG. 7 is a diagram showing a configuration of a flag F and a register R of the stream separation unit;

FIG. 8 is a flowchart showing the process of STC initialization;

FIG. 9 is a flowchart sowing the pack process of the stream separation unit;

FIG. 10 is a flowchart showing the video packet process of the stream separation unit;

FIG. 11 is a flowchart showing the audio packet process of the stream separation unit;

FIG. 12 is a flowchart showing the sub-picture packet process of the stream separation unit;

FIG. 13 is a diagram showing the reproduction process with continuous time stamps;

FIG. 14 is a flowchart showing the STC discontinuity process of the stream separation unit;

FIG. 15 is a flowchart showing the seamless reproduction process of the stream separation unit;

FIG. 16 is a diagram showing the seamless reproduction process with discontinuous time stamps;

FIG. 17 is a flowchart showing the non-seamless reproduction process of the stream separation unit;

FIG. 18 is a diagram showing the non-seamless reproduction process with discontinuous time stamps;

FIG. 19 is a flowchart showing the underflow process of the stream separation unit;

FIG. 20 is a diagram showing the underflow process; and

FIG. 21 is a diagram showing the layer structure of an MPEG1 system stream.

### DETAILED DESCRIPTION OF THE INVENTION

Embodiments of the invention will be described in detail below with reference to the accompanying drawings.

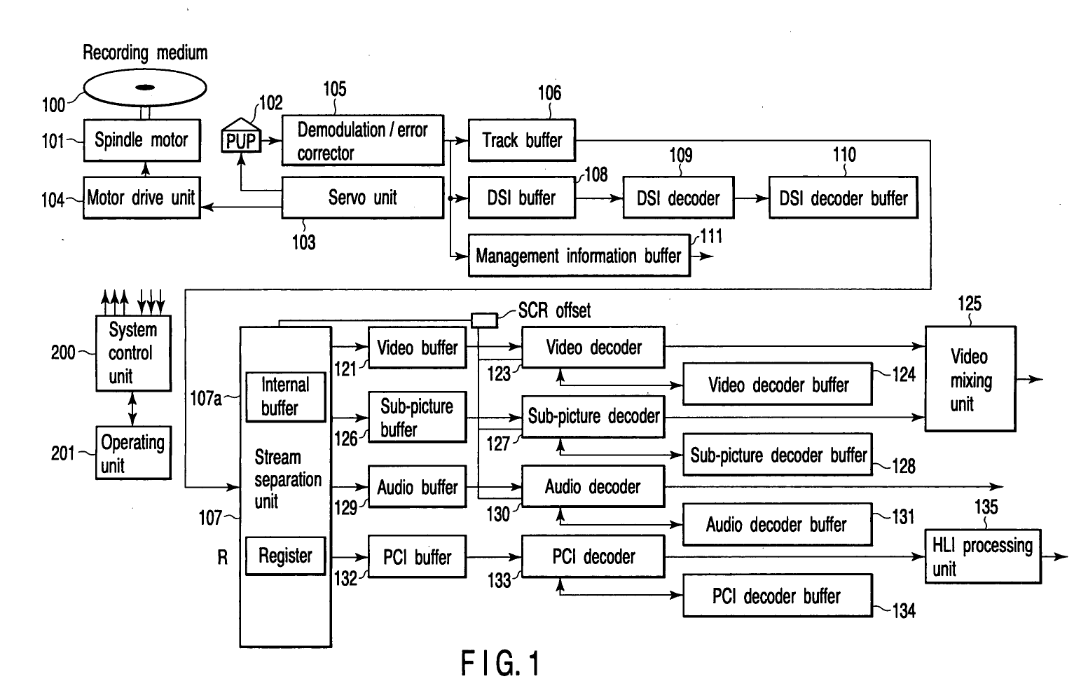

FIG. 1 is a block diagram showing a configuration of an audio/video reproduction apparatus according to an embodiment of the invention.

A recording medium 100 loaded on a turntable (not shown) is rotated by a spindle motor 101. During the reproduction, information recorded in the recording medium 100 is read by a pickup unit (PUP) 102. A servo unit 103 performs feed control in a disk radial direction, focus control, and tracking control of the pickup unit 102. During the reproduction, the servo unit 103 also transmits a control signal to a motor drive unit 104 to perform rotational control of the spindle motor 101, i.e. the rotational control of the recording medium 100.

An output signal of the pickup unit 102 is inputted to a demodulating/error correction unit 105 to perform demodulation and error correction. The error corrected data is inputted to a stream separation unit 107 through a stream buffer 106. The error corrected data is input to a DSI decoder 109 through a DSI (Data Search Information) buffer 108. The DSI decoder 109 is connected to a DSI decoder buffer 110. The decoded DSI is transmitted to a system control unit 200. The error corrected data is also transmitted to the system controller 200 through a management information buffer 111. The later-mentioned VMGI and VTSI are written in the management information buffer 111, and the system control unit 200 reads the information such as VMGI and VTSI to perform reproduction control. The management information indicates the management information for managing the MPEG system stream such as VMGI and VTSI.

The stream separation unit 107 performs a process of separating each pack. A video pack (V_PCK) fetched by the stream separation unit 107 is input to a video decoder 123 through a video buffer 121 and decoded by the video decoder 123. The video decoder 123 is connected to a video decoder buffer 124. A video signal output from the video decoder 123 is input to a video mixing unit 125.

A sub-picture pack (SP_PCK) fetched by the stream separation unit 107 is input to a sub-picture decoder 127 through a sub-picture buffer 126 and decoded by the sub-picture decoder 127. The sub-picture decoder 127 is connected to a sub-picture decoder buffer 128. A sub-picture output from the sub-picture decoder 127 is input to the video mixing unit 125. Therefore, a signal in which the sub-picture is superimposed on a main video signal is obtained from the video mixing unit 125, and the signal is supplied to a display.

An audio pack (A_PCK) fetched by the stream separation unit 107 is input to an audio decoder 130 through an audio buffer 129 and decoded by the audio decoder 130. The audio decoder 130 is connected to an audio decoder buffer 131. A/D conversion (not shown) of the output of the audio decoder 130 is performed and supplied to a speaker. A PIC (Presentation Control Information) pack fetched from the stream separation unit 107 is input to a PCI decoder 133 through a PCI buffer 132 and decoded by the PCI decoder 133. The PCI decoder 133 is connected to a PCI decoder buffer 134. The output of the PCI decoder 133 is input to a highlight information (HLI) processing unit 135.

Thus, the sub-picture (subtitles and characters) information, the audio information, the management information, the control information are recorded in the recording medium 100 corresponding to the video information. The main video information, the sub-picture (subtitles and characters) information, the audio information, the management information, the control information, and the like are separated and derived in the stream separation unit 107. In this case, various languages can be selected as the sub-picture (subtitles and characters) information and the audio information, and the selection is performed under the control of system control unit 200. User's input operation is given to the system control unit 200 through an operation unit 201. Decoding processing corresponding to a type of the display device is performed in the video decoder 123 which decodes the main video information. For example, the main video information is converted into NTSC, PAL, SECAM, a wide screen, or the like. The audio information of the stream specified by the user is input to and decoded by the audio decoder 130. The sub-picture data of the stream specified by the user is also input to and decoded by the sub-picture decoder 127.

Then, an outline of a DVD video stream will be described.

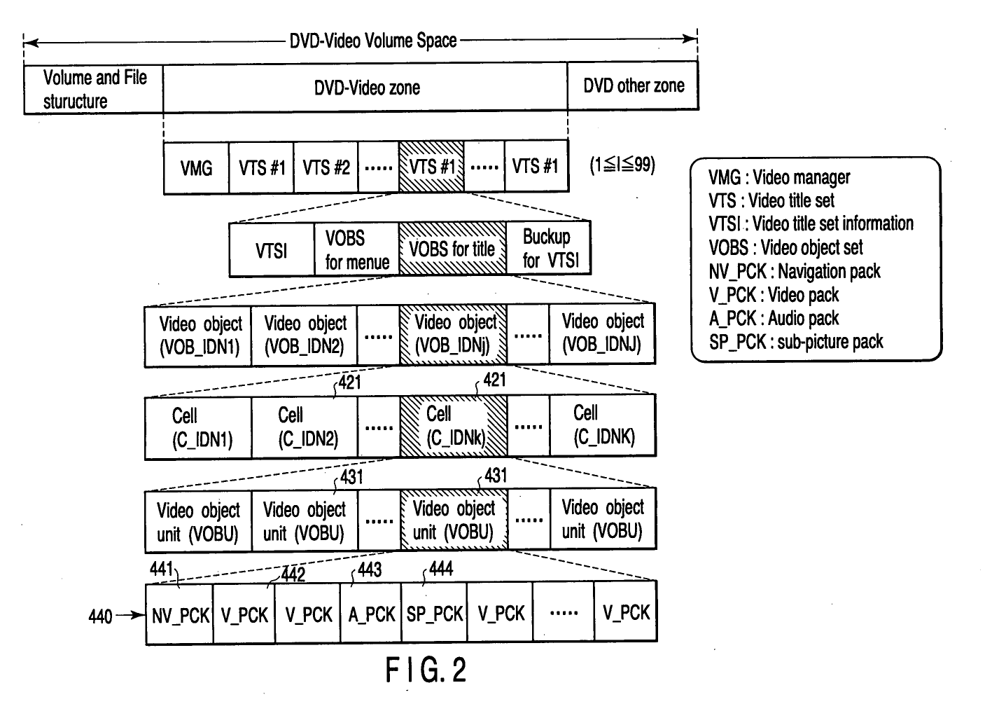

FIG. 2 shows a stream structure of the DVD video. The DVD stream is formed by continuous video object units (VOBU) 431 which are of a minimum access unit. VOBU 431 is pursuant to the MPEG-2 program stream. VOBU 431 always starts from a navigation pack (NV_PCK) 441, and then a video pack (V_PCK) 442, a sub-picture pack (SP_PCK) 444, and an audio pack (A_PCK) 443 are continuously formed.

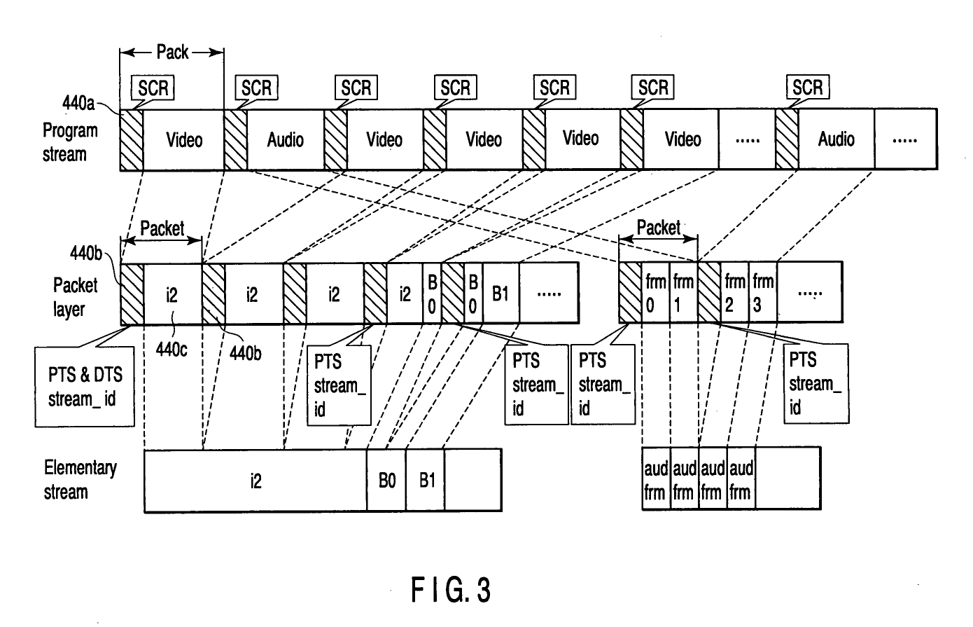

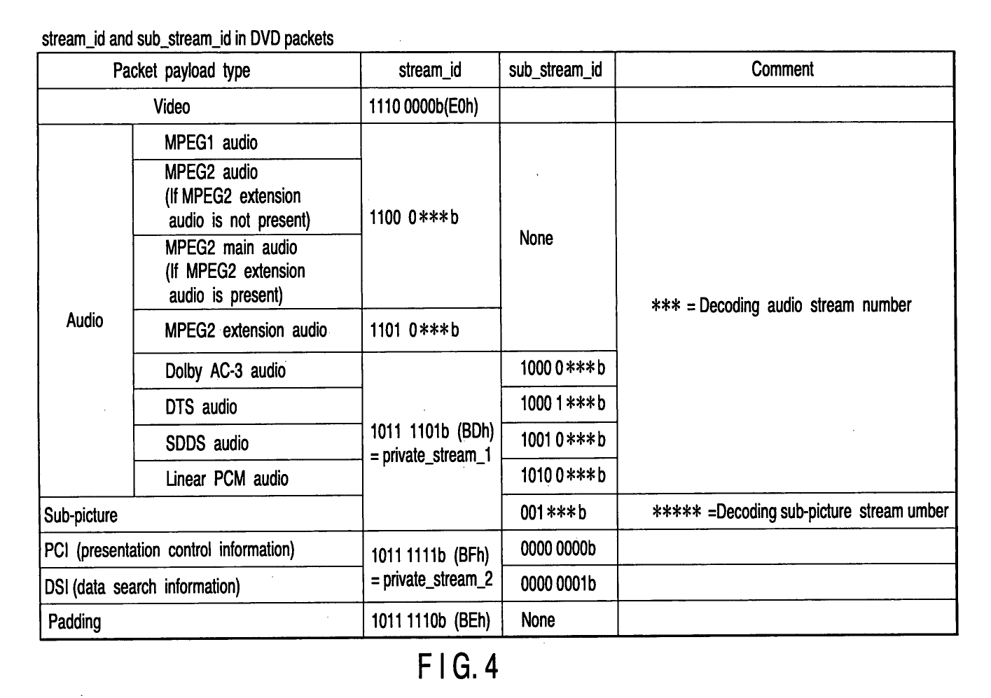

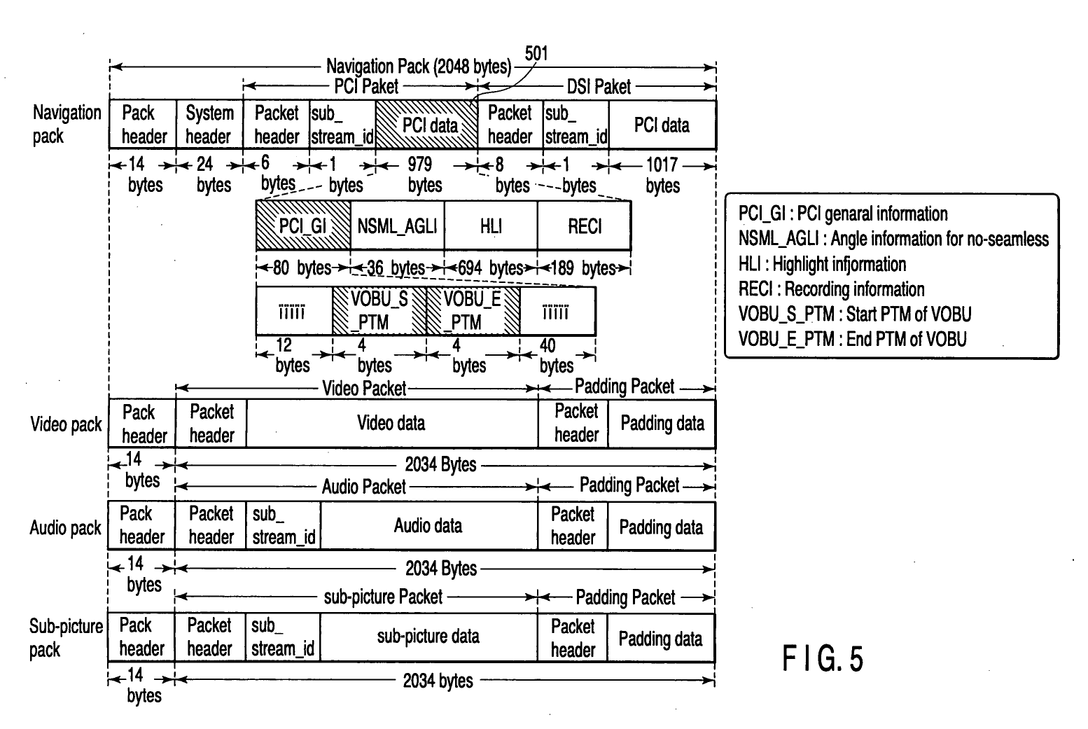

FIG. 3 shows a configuration of a program stream 440, FIG. 4 is a diagram showing stream_id of the DVD-video and FIG. 5 is a diagram showing the pack structure of the DVD-video. As shown in FIG. 3. time information SCR (System Clock Reference) in which the pack reaches an input buffer (video buffer 121, sub-picture suffer 126, audio buffer 129, and PCI buffer 132 in FIG. 1) of each elementary decoder is described in a pack header 440a. Each pack can have at least one packet. A payload (a part except a packet header) 440c of the packet can have only single piece (one type) of elementary data. For example, the video data and the audio data can not be mixed together as one payload of the packet.

In a packet header 440b of each packet, stream_id is described. For the packet having private_stream_{—}1 (=BDh) and private_stream_{—}2 (=BFh) as stream_id, sub_stream_id is described in the first byte of the payload of the packet (see FIG. 4).

When a leading edge of the picture data is included in the video packet 442, the time DTS (Decoding Time Stamp) or the time PTS (Presentation Time Stamp) for the picture which includes the leading edge can be described in the packet header 440b of the video packet. The time DTS shows when the picture is decoded and the time PTS shows when the picture is displayed.

When the picture is an I picture or a P picture, DTS and PTS can be described in the packet header 440b. When the picture is a B picture, only PTS can be described in the packet header 440b.

When the leading edge of an audio frame is included in the audio packet 443, the time PTS for the audio frame which includes the leading edge can be described in the packet header 440b of the audio packet. The time PTS of the audio packet shows when the audio frame is decoded and presented.

When the leading edge of a sub-picture unit (SPU) is included in the sub-picture packet, the time PTS for the sub-picture unit which includes the leading edge can be described in the packet header 440b of the sub-picture packet 444. The time PTS of the sub-picture packet shows when a sub-picture display control sequence (SP_DCSQ) of the lead of the sub-picture unit is performed.

In the packet header of the PCI packet 501 (see FIG. 5) in the navigation pack, there is no field in which the time information is written.

Then, a basic operation of the steam separation unit 107.

When the stream separation unit 107 detects the packet having the same value as stream_id and sub_stream_id, the stream separation unit 107 separates the payload of the packet to input the payload to the input buffers (the video buffer 121, the sub-picture buffer 126, the audio buffer 129, and the PCI buffer 132 in FIG. 1) of the corresponding elementary decoders as shown in FIG. 3. Accordingly, the video elementary stream is stored in the video buffer 121, the sub-picture elementary stream is stored in the sub-picture buffer 126, the audio elementary stream is stored in the audio buffer 129, and the PCI elementary stream is stored in the PCI buffer 132.

The stream separation unit 107 resets all system time clocks (STC) in the system with the value of SCR of the pack during the startup and transmits the PTS and DTS, which are separated from the packet of each elementary stream, to each elementary decoder (the video decoder 123, the sub-picture decoder 127, and the audio decoder 130 in FIG. 1). Each elementary decoder compares the time (STC) owned by each elementary decoder itself to PTS and DTS, which are received from the stream separation unit 107, to perform the decoding and/or the display when a value of the STC coincides with PTS or DTS, for example.

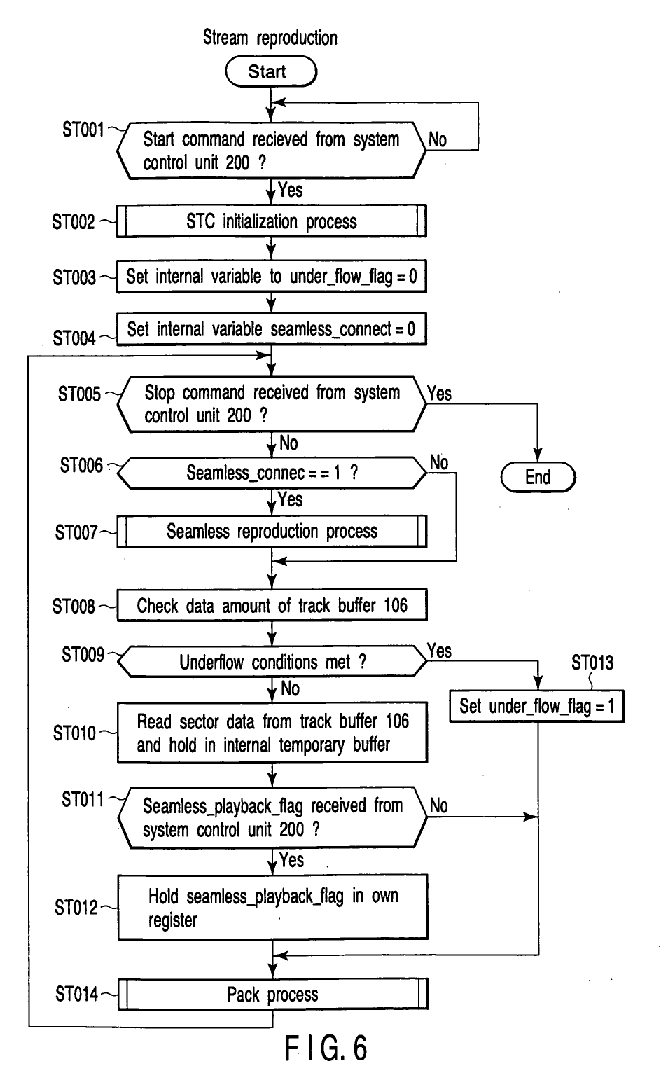

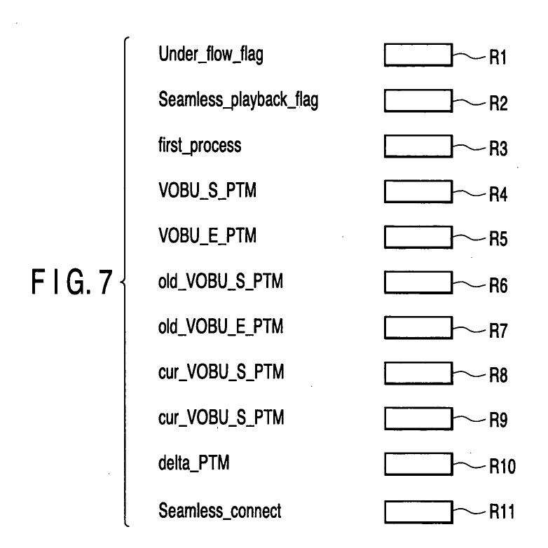

FIG. 6 is a flowchart showing an outline of the stream reproduction process of the stream separation unit 107, and FIG. 7 a diagram showing the configuration of the flags F and the registers R of the stream separation unit 107.

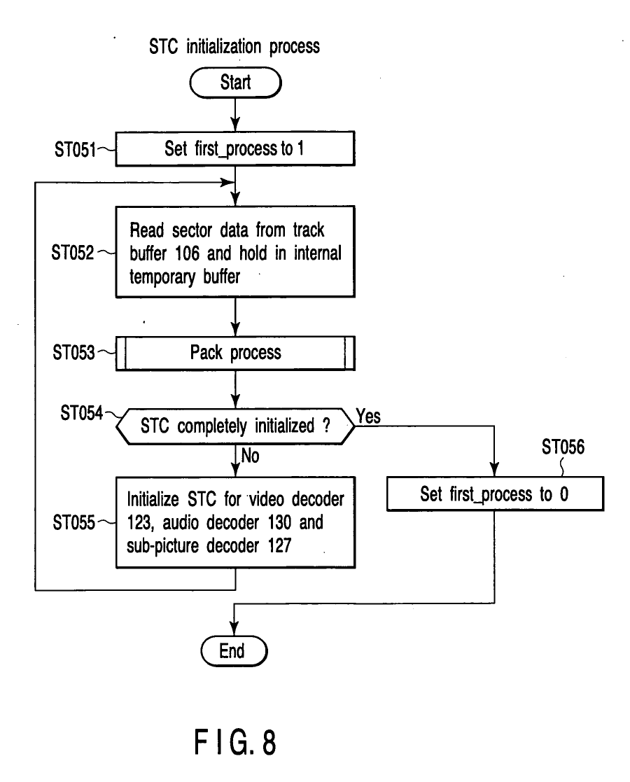

The stream separation unit 107 determines whether or not a start command has been received from the system control unit 200 (ST001), and in the case where it has been so received, initializes the STC in step ST002. FIG. 8 is a flowchart showing the STC initialization process. The stream separation unit 107 sets the register R3 of the first_process to “1” (ST051), reads the sector data (pack data) from the track buffer 106, and holds it temporarily in the buffer 107a (ST052). Next, the stream separation unit 107 executes the pack process (described later) in step ST053. Unless the STC initialization is complete as in step ST054, the stream separation unit 107 sets the STC in the video decoder 123, the audio decoder 130 and the sub-picture decoder 27 (ST055). The process flow returns to step ST052 where the stream separation unit 107 executes steps ST052, ST053 and ST054, and resets the first_process register R3 to “0” as in step ST056.

By executing the pack process (ST053) in this initialization process, the VOBU_S_PTM of the first VOBU is stored in the old_VOBU_S_PTM register R6, the VOBU_E_PTM of the first VOBU is stored in the old_VOBU_E_PTM register R7, the VOBU_S_PTM of the second VOBU is stored in the cur_VOBU_S_PTM register R8, and the VOBU_S_PTM of the second VOBU is stored in the cur_VOBU_E_PTM register R9. The time information such as VOBU_S_PTM, old_VOBU_S_PTM and old_VOBU_E_PTM are described later.

Returning to FIG. 6, the stream separation unit 107 sets the under_flow_flag register R1 to “0” as in step ST003, sets the seamless_connect register R11 to “0”, and determines in step ST005 whether the stop command has been received or not from the system control unit 200. The under_flow indicates the state in which the data of more than a predetermined amount is not stored in the track buffer 106 when the stream separation unit 107 reads the data from the track buffer 106. This state occurs in the case where the reproduction signal from the disk ceases for some time such as when an impact is applied to the device (pickup head 102) or the layer is duplicated (switched) at the time of parallel double-layer disk reproduction.

In the case where the stop command has been received, the stream reproduction operation is stopped, while in the case where the stop command has not been received, on the other hand, the stream separation unit 107 checks to see whether the seamless connection flag (seamless_connect) is “1” or not, and when it is “1”, executes the seamless reproduction process. Otherwise, the stream separation unit 107 checks the amount of the data transferred to the track buffer 106. In the case where the data amount fails to satisfy the underflow conditions, the stream separation unit 107, like in step ST010, reads the data of one sector from the track buffer 106 and holds it in the internal buffer 107a. Next, the stream separation unit 107 determines whether or not the seamless_playback_flag has been received from the system control unit 200 (ST011), and when it is received, sets the seamless_playback_flag register R2 to “1” and executes the pack process in step ST014. The seamless_playback_flag indicates whether the seamless connection (reproduction) is guaranteed or not for the stream in process, and when this flag is “1”, the seamless connection is guaranteed. The seamless_playback_flag is the information detected by the system control unit 200 from the information of the management information buffer 111 and transmitted to the stream separation unit 107. In the case where the data amount satisfies the underflow conditions in step ST009, on the other hand, the under_flow_flag register R1 is set to “1” as in step ST016.

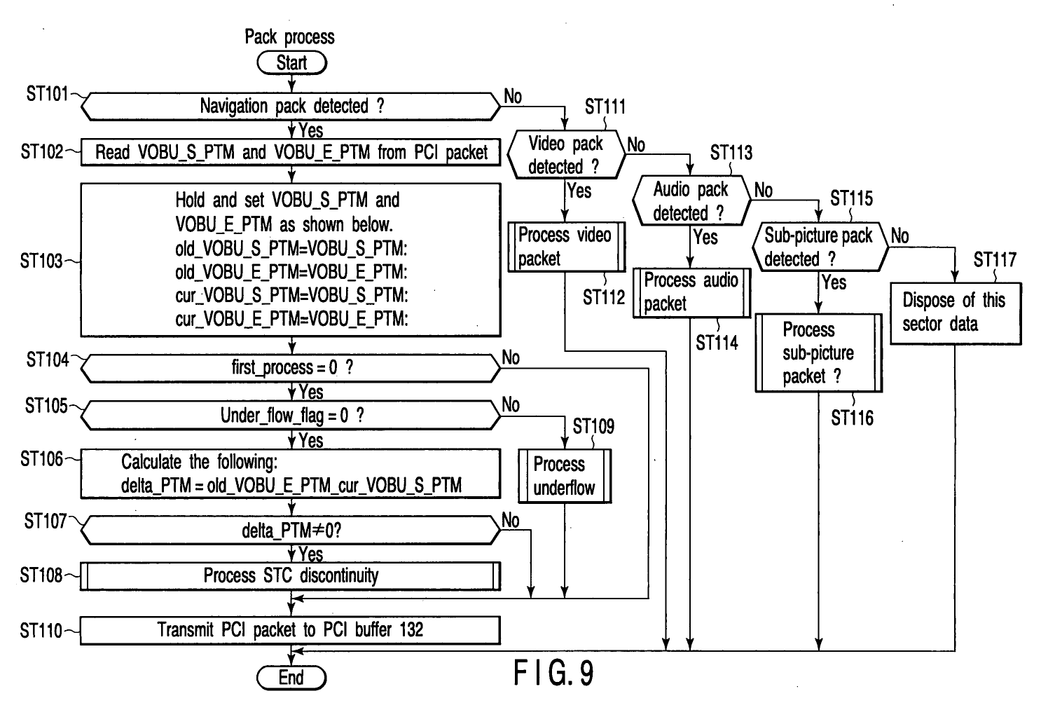

FIG. 9 is a flowchart showing the pack process in step ST014.

The stream separation unit 107 determines whether or not the navigation pack 441 has been detected (ST101), and in the case where it is detected, reads VOBU_S_PTM and VOBU_E_PTS from the PCI packet 501 (ST102), and holds VOBU_S_PTM and VOBU_E_PTS (FIG. 5) in the registers R4 and R5, respectively. In step ST103, the stream separation unit 107 updates the old_VOBU_S_PTM register R6 and old_VOBU_E_PTM register R7, the cur_VOBU_S_PTM register R8 and the cur_VOBU_E_PTM register R9. In the case where the first_process register R3 is “0” (ST104), the stream separation unit 107 determines whether or not the under_flow_flag register R1 is “0” (ST105). In the case where the under_flow_flag register R1 is not “0”, the difference between the contents of the registers R7 and R8, i.e. the difference delta_PTM between VOBU_E_PTM and VOBU_S_PTM is calculated, and the calculation result is stored in the delta_PTM register R10. In the case where the delta_PTM is “0” (NO in ST107), i.e. the time stamps are continued between successive VOBU s or cells, on the other hand, the stream separation unit 107 transmits the PCI packet to the PCI buffer 132 (ST110). After that, the stream separation unit 107 returns to the flow shown in FIG. 6, and as described above, executes steps ST005 to ST012. In this way, the sector data (pack data) are held in the internal buffer 107a. The sector data held in the internal buffer 107a is analyzed, and when the video pack is detected (YES in ST111), the stream separation unit 107 executes the video packet process of step ST112.

FIG. 10 is a flowchart showing the video packet process.

The stream separation unit 107 determines in step ST201 whether or not PTS and DTS or PTS alone is contained in the packet header, and in the presence of PTS and DTS or PTS alone therein, transmits PTS and DTS or PTS alone, as the case may be, to the video decoder 123 (ST202). Further, the stream separation unit 107 transmits the elementary data stored in the internal buffer 107a to the video buffer 121 (ST203). The process returns to the flowchart of FIG. 6 through the flowchart of FIG. 9, and steps ST005 to ST012 are executed as described above, so that the next sector data are held in the internal buffer 107a and analyzed. In the case where the audio pack is detected as the result of analyzing the sector data held in the internal buffer 107a (YES in ST113), the stream separation unit 107 executes the audio packet process in step ST114.

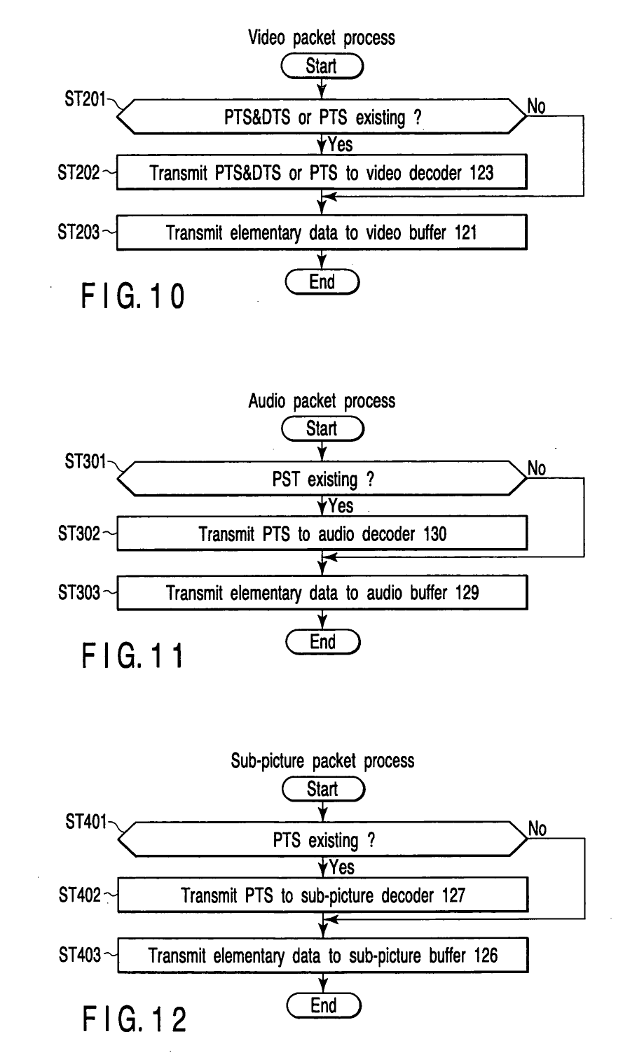

FIG. 11 is a flowchart showing the audio packet process.

The stream separation unit 107 determines in step ST301 whether or not PTS is contained in the packet header, and in the case where it is so contained, transmits the PTS to the audio decoder 130 (ST302). Further, the stream separation unit 107 transmits the elementary data stored in the internal buffer 107a to the audio buffer 129 (ST303). The process returns to the flowchart of FIG. 6 through the flowchart of FIG. 9, and as described above, steps ST005 to ST012 are executed. In this way, the next sector data are held in the internal buffer 107a and analyzed.

In the case where the sub-picture pack is detected as the result of analyzing the sector data held in the internal buffer 107a (YES in ST115), the stream separation unit 107 executes the sub-picture packet process in step ST116. In the case where no sub-picture pack could be detected in step ST115 (NO in ST115), on the other hand, the stream separation unit 107 disposes of the sector data (ST117).

FIG. 12 is a flowchart showing the sub-picture packet process.

In step ST401, the stream separation unit 107 determines whether PTS is contained in the packet header, and in the case where PTS is so contained, transmits the PTS to the sub-picture decoder 127 (ST402). Further, the stream separation unit 107 transmits the elementary data stored in the internal buffer 107a to the sub-picture buffer 126 (ST403).

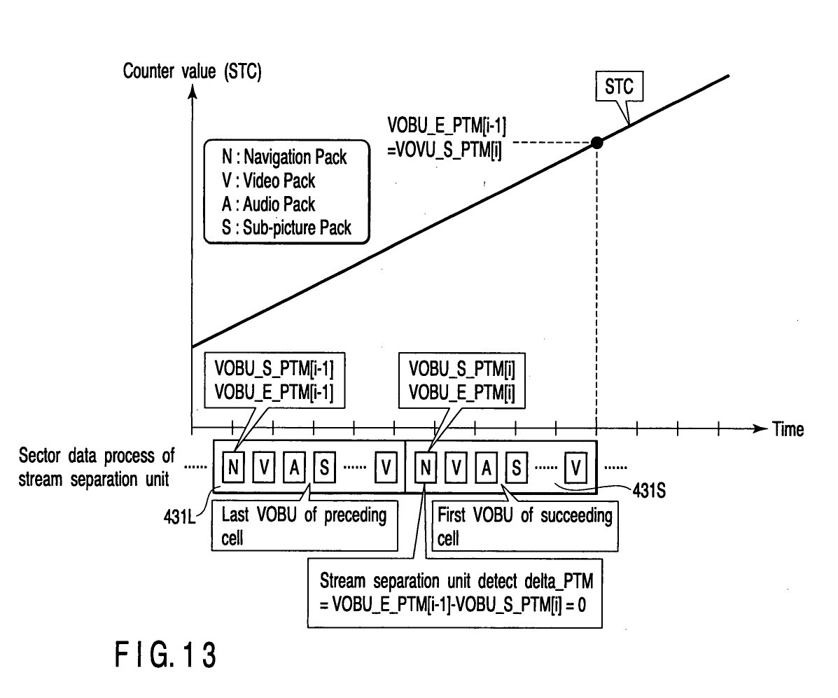

FIG. 13 is a diagram showing the normal reproduction process in the case where the time stamps (PTS/DTS) of the adjacent VOBUs (or cells) are continuous (corresponding to the case where the answer is NO in step ST107 in the flowchart of FIG. 9).

In DVD video, the reproduction is carried out for each VOBU 431, and at other than the connection portion of the cells 421, the reproduction end time (VOBU_E_PTM) of the preceding VOBU and the reproduction start time (VOBU_S_PTM) (FIG. 5) of the succeeding VOBU are equal to each other. In the case where the time stamps are continuous between the cells 421, the reproduction end time (VOBU_E_PTM) of the last VOBU 431L of the preceding cell is equal to the reproduction start time (VOBU_S_PTM) of the first VOBU 431S of the succeeding cell. In this case, the stream separation unit 107 performs no STC control, and each elementary decoder (the video decoder 123, the sub-picture decoder 127 and the audio decoder 130 in FIG. 1) compares the clock (STC) of itself with the PTS and DTS received from the stream separation unit 107. In the case of coincidence between them or STC with an offset value coincides with the PTS or DTS, each elementary decoder decodes or displays corresponding data in the packet. When the time stamps between cells are discontinuous, on the other hand, whether the seamless connection is possible or not is recognized by receiving the flag (seamless_playback_flag) from the system control unit 200 before cell reproduction.

In the case where the answer is YES in step ST107 in the flowchart of FIG. 9, i.e. in the case where the delta_PTM is not zero but the time stamps are discontinuous between successive VOBU s or cells, the stream separation unit 107 executes the STC discontinuity process of step ST108.

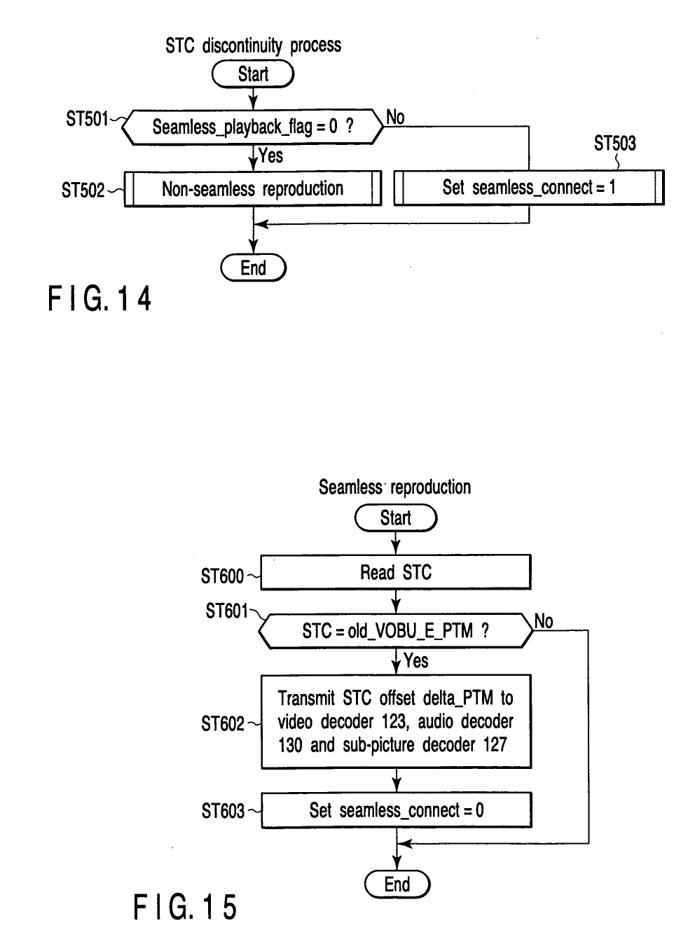

FIG. 14 is a flowchart showing the STC discontinuity process. The stream separation unit 107 determines whether the register R2 of seamless_playback_flag is zero or not (ST501), and in the case where the answer is NO (the seamless reproduction is not set), “1” is set in the seamless connection flag (seamless_connect) register R11. Once the flag is set to “1” in ST701 in FIG. 6, the seamless reproduction process is executed.

FIG. 15 is a flowchart showing the seamless reproduction process in the case where the time stamps (PTS/DTS) are not continuous. The stream separation unit 107 reads the STC counter, and when the STC value comes to coincide with the value on the old_VOBU_E_PTM register R7 (YES in ST601), STC offset, i.e. delta_PTM is transmitted to the video decoder 123, the audio decoder 130 and the sub-picture decoder 27, and “0” is set in the seamless_connect register R11 (ST602).

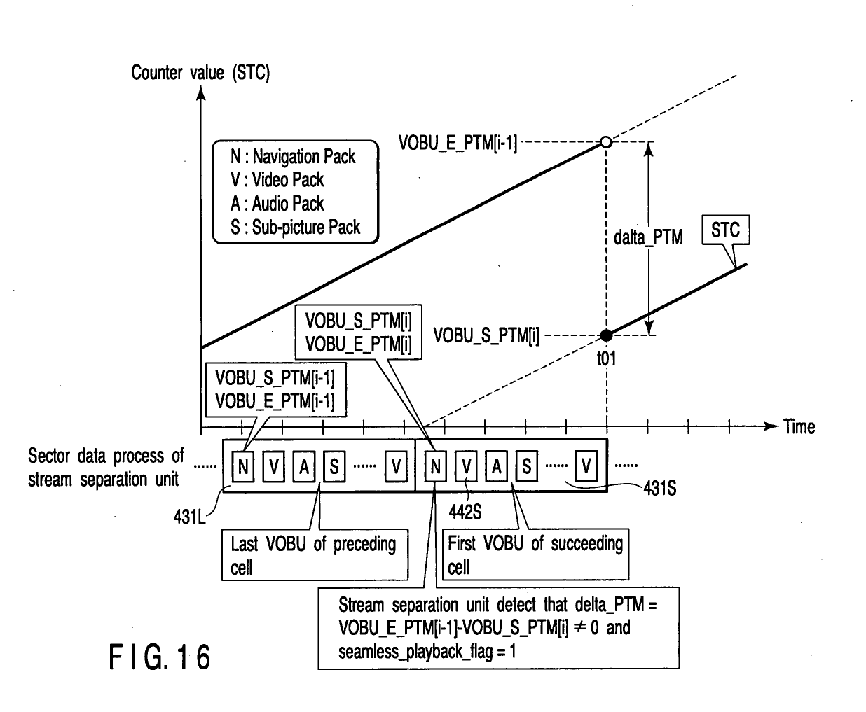

FIG. 16 is a diagram showing the mode of seamless reproduction process.

In the case where the time stamps become discontinuous between cells, the reproduction end time (VOBU_E_PTM) of the last VOBU 431L of the preceding cell fails to be equal to the reproduction start time (VOBU_S_PTM) of the first VOBU 431S of the succeeding cell.

In the case where the preceding cell and the succeeding cell can be seamlessly reproduced (seamless_playback_flag=1), then the stream separation unit 107 transmits the offset delta_PTM (>0) to each elementary decoder (the video decoder 123, the sub-picture decoder 127 and the audio decoder 130 in FIG. 1) at the reproduction end time (VOBU_E_PTM) t01 of the last VOBU 431L of the preceding cell. Each elementary decoder (the video decoder 123, the sub-picture decoder 127 and the audio decoder 130 in FIG. 1) subsequently compares PTS and DTS received from the stream separation unit 107 with the clock (STC) of itself less the offset delta_PTM (>0) of the receiving time (STC=STC−delta_PTM), for decoding and display. In the process, the image and the sound are reproduced (normally) in synchronism with each other. In this way, VOBU for which seamless_playback_flag is set to “1” is reproduced by being connected seamlessly to VOBU following the preceding VOBU simply by applying the time offset delta_PTM to each elementary decoder.

Returning to FIG. 14, in the case where the seamless_playback_flag is “0” (YES in ST501), the stream separation unit 107 executes the non_seamless reproduction process (ST502) according to an embodiment of the invention.

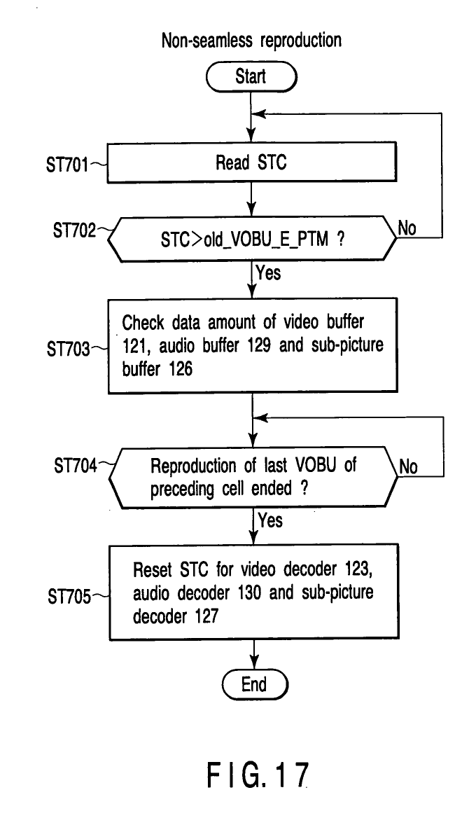

FIG. 17 is a flowchart showing the non_seamless reproduction process in the case where the time stamps are not continuous.

The stream separation unit 107 reads STC (ST702), and in the case where STC increases beyond old_VOBU_E_PTM (YES in ST702), checks the data amount in the video buffer 121, the audio buffer 129 and the sub-picture buffer 126 (ST703), and determines whether the reproduction of the last VOBU of the preceding cell is ended or not (ST704). Once the reproduction of the last VOBU is ended, the stream separation unit 107 resets STC again for the video decoder 123, the audio decoder 130 and the sub-picture decoder 127. (ST705).

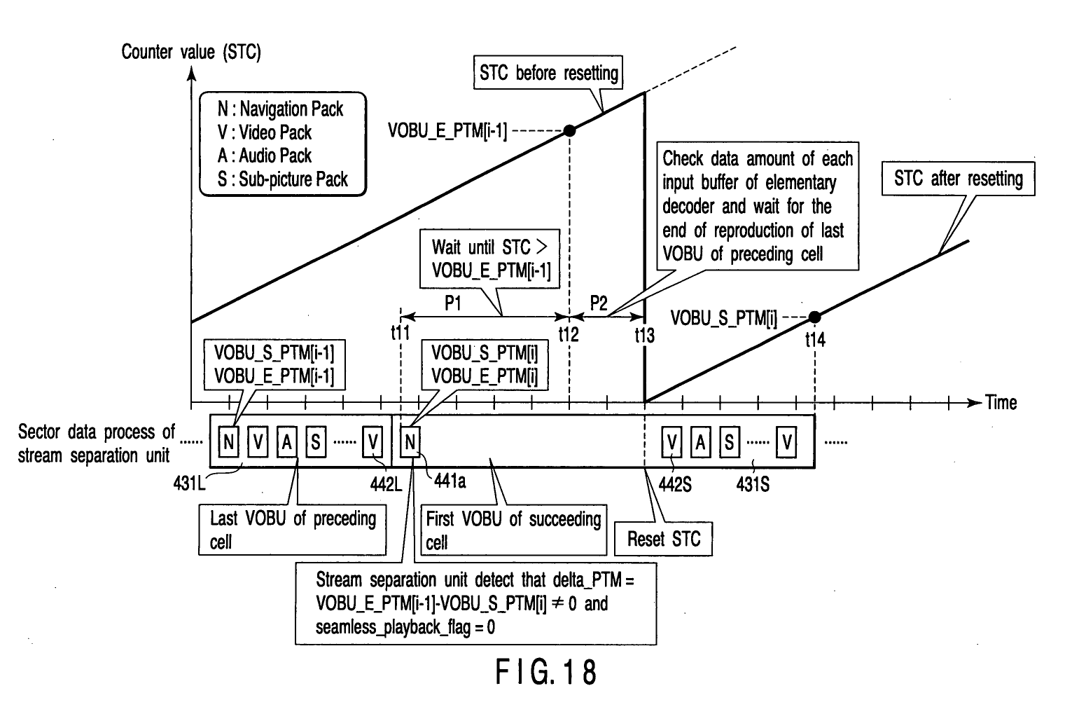

FIG. 18 is a diagram showing the mode of the non_seamless reproduction process.

At time point t11, the stream separation unit 107 starts analyzing the navigation pack 441a, and then detects that the reproduction end time VOBU_E_PTM[i−1] of the last VOBU 431L of the preceding cell fails to coincide with the reproduction start time VOBU_S_PTM[i] of the first VOBU 431S of the succeeding cell and that the register R2 of seamless_playback_flag is “0”, i.e. the seamless reproduction is not set. The stream separation unit 107 stops the transfer operation for the period of P1 until the value STC reaches VOBU_E_PTM[i−1].

Once the STC value reaches VOBU_E_PTM[i−1] at time point tl2, it indicates that the reproduction of the video pack 442L is ended. In view of the fact that the reproduction of the audio pack and the sub-picture pack may not be ended, the stream separation unit 107 checks the data amount of the input buffers 124, 128, 131 of the elementary decoders 123, 127, 130 during the period P2, and waits until the reproduction of all VOBUs in the preceding cell is ended. Upon confirmation that the reproduction of all the VOBUs of the preceding cell is ended at time point t13, the stream separation unit 107 resets STC and restarts the pack process. In the process, the stream separation unit 107 resets STC using, for example, the PTS value of the first I pictures (video pack 442S) of the succeeding cell 431S.

In FIG. 18, the reproduction of the video pack 442S is started at time point t14.

In the case where the seamless reproduction process shown in FIG. 16, for example, is executed on the discontinuous stream not set for the seamless reproduction, the reproduction of the video pack 442S is started at time point t01 when delta_PTM is transmitted. Since the reproduction of the audio pack of the preceding VOBU is still continued, however, a gap (displacement) accurred between the image and the sound. According to the embodiment shown in FIG. 18, the reproduction of the first VOBU 431S of the succeeding cell is started only after complete reproduction of all the packs (the video pack, the audio pack and the sub-picture pack) of the last VOBU 431L of the preceding cell (after the elementary buffers 124, 128, 131 become vacant). Therefore, the image and the sound are reproduced in synchronism with each other. Since the operation of the subsequent-stage decoder is not stopped nor the disk searched again unlike in the prior art, the reproduction stop time becomes shorter and the pseudo seamless connection becomes possible.

Returning to FIG. 9, in the case where the register R1 of under_flow_flag is “0” in step ST105, i.e. the underflow occurs in the track buffer 106, the stream separation unit 107 executes the underflow process of step ST109.

In the case where the DVD or video CD reproduction device causes an underflow of the track buffer due to the layer duplication (layer switching) at the time of the parallel double-layer disk reproduction or the vibration, the system cock STC advances. For lack of the input data to be decoded, however, a large error occurs between the STC and the time stamps of the stream. According to this embodiment, even in the case where the underflow of the track buffer 106 occurs and a large displacement occurs between the system clock STC and the time stamps of the stream, the clock can be adjusted instantaneously.

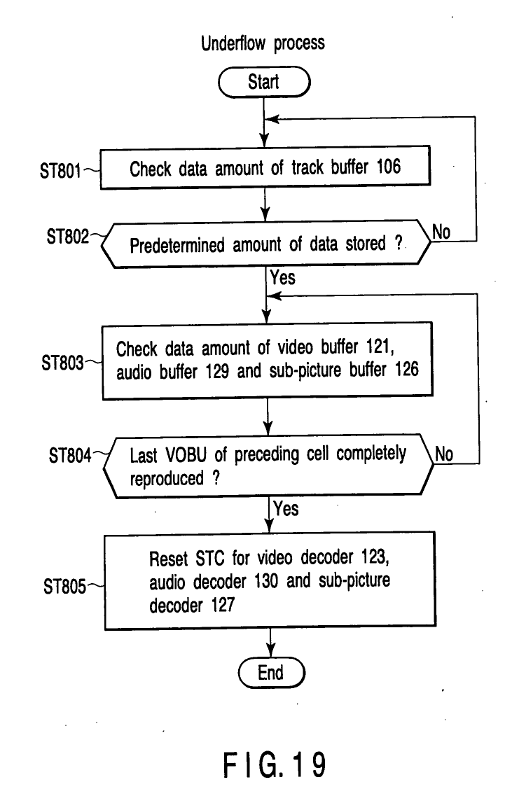

FIG. 19 is a flowchart showing the underflow process.

The stream separation unit 107 checks the data amount of the track buffer 106 (ST801), and determines whether a predetermined amount of data has been stored or not (ST802). Once the predetermined amount of data are stored in the track buffer 106, the stream separation unit 107 checks the data amount of the video buffer 121, the audio buffer 129 and the sub-picture buffer 126 (ST803) and determines whether the reproduction of the last VOBU of the preceding cell is ended or not (ST804). At the end of the reproduction of the last VOBU of the preceding cell, the stream separation unit 107 resets the STC for the video decoder 123, the audio decoder 130 and the sub-picture decoder 127 (ST805).

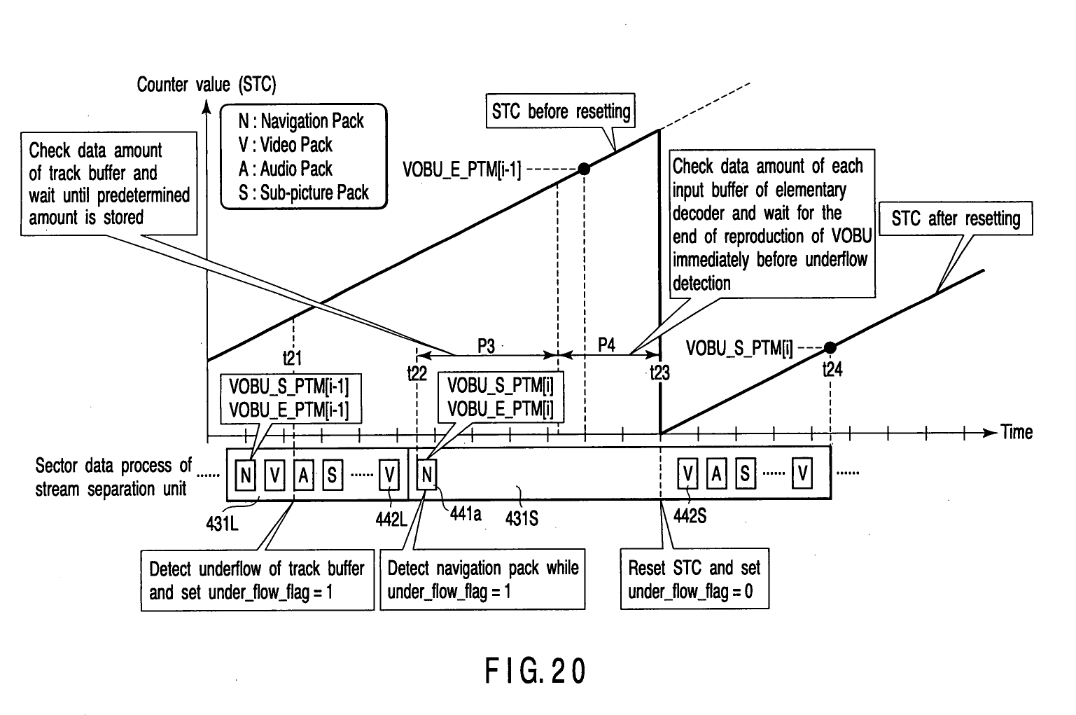

FIG. 20 is a diagram showing the underflow process.

The stream separation unit 107 detects an underflow of the track buffer 106 at time point t21 during the process of the VOBU 431, and sets the under_flow_flag register R1 to “1”. After that, the stream separation unit 107 reads the data from the track buffer and writes the data in the input buffer of each elementary decoder in the subsequent stages until the head (pack header of the navigation pack 441a) of the next VOBU (VOBU 431S in FIG. 20) is detected. At time point t22, the stream separation unit 107 starts the analysis of the navigation pack 441a, and detects that the under_flow_flag register R1 is “1”. During the period P3, the stream separation unit 107 stops reading the data from the track buffer 106 and writing the data in the elementary buffers 124, 128, 131 in the subsequent stages, and while checking the data amount of the track buffer 106, waits for the accumulation of a predetermined amount of data.

During the period P4, the stream separation unit 107 checks the data amount of the input buffers 124, 128, 131 of the elementary decoders, and waits for the end of the reproduction of the preceding VOBU 431L. At time point t23, the stream separation unit 107 resets the STC and sets the register R1 of under_flow flag to “0”. In the process, the stream separation unit 107 resets the STC using, for example, the PTS value of the fist I picture (video pack 442S) of the succeeding VOBU 431S. In FIG. 20, the reproduction of the video pack 442S is started at time point +24.

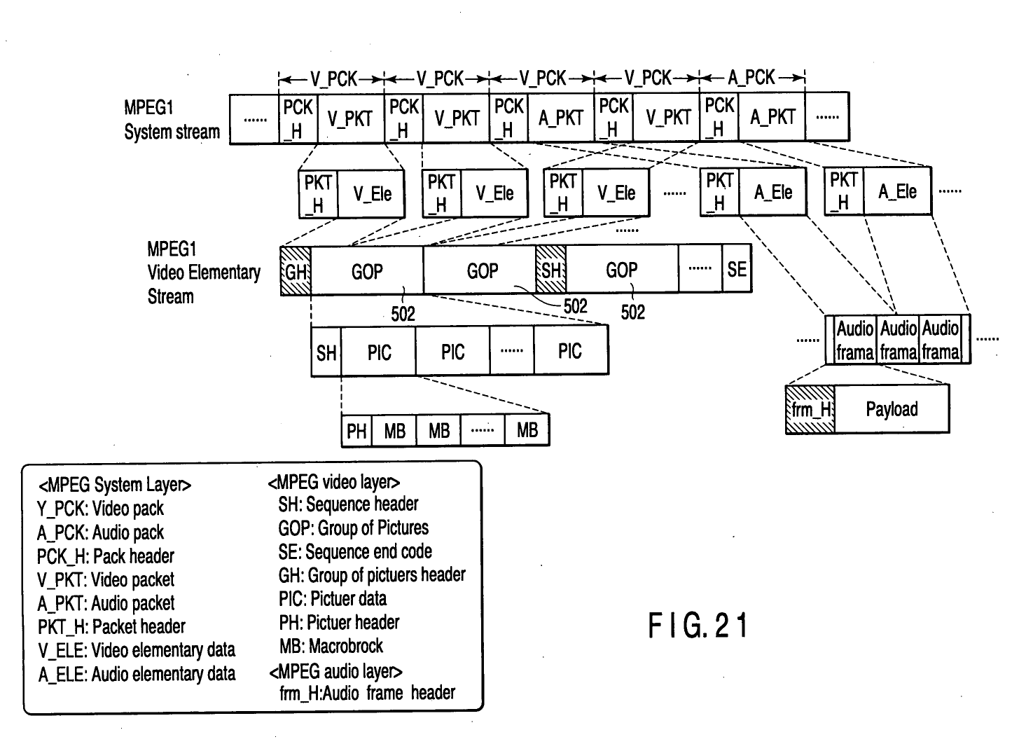

As described above, according to this embodiment, even in the case where an underflow of the track buffer 106 occurs and a large displacement occurs between the system clock STC and the time stamps of the stream, the clock can be readjusted instantaneously. In the description above, the VOBU of the MPEG2 program stream corresponds to the GOP (group of pictures) of the MPEG1 system stream. FIG. 21 is a diagram showing the layer structure of the MPEG1 system stream. In reproducing the MPEG1 system stream for the video CD, etc., the invention is applicable by replacing the VOBU with the GOP 502.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An audio/video reproduction apparatus comprising:
a stream separation unit which separates a video stream and an audio stream from an MPEG stream read from a medium;
a first storage unit which stores the video stream separated by the stream separation unit;
a second storage unit which stores the audio stream separated by the stream separation unit;
a clock unit which provides the reference time of operation;
a video decoder which reads the video stream stored in the first storage unit and reproduces by decoding the video stream based on the value on the clock unit; and
an audio decoder which reads the audio stream stored in the second storage unit and reproduces by decoding the audio stream based on the value on the clock unit,
the stream separation unit comprising:
a determining unit which determines the continuity of time stamps between a preceding VOBU (video object unit) and a succeeding VOBU midway of the MPEG stream read;
a stop unit which stops the operation of writing the data in the first and second storage units until the end of reproduction of the preceding VOBU stored in the first and second storage units by the video decoder and the audio decoder in the case where the discontinuity of the time stamps is detected by the determining means;
a change unit which changes the value on the clock unit; and
a restart unit which restarts the operation of writing the data including and subsequent to the succeeding VOBU in the first and second storage units upon completion of reproduction of the preceding VOBU.

2. An audio/video reproduction apparatus according to claim 1,
wherein the determining unit determines the continuity of the time stamps between the preceding GOP (group of pictures) and the succeeding GOP,
the stop unit stops the operation of writing the data in the first and second storage units until the end of reproduction of the preceding GOP stored in the first and second storage units and the audio data corresponding to the preceding GOP by the video decoder and the audio decoder, and
the restart unit restarts the operation of writing the data in the succeeding GOPs in the first and second storage units at the end of the reproduction of the preceding GOP and the audio data corresponding to the preceding GOP.

3. An audio/video reproduction apparatus according to claim 1,
wherein the change unit changes the value on the clock unit based on the PTS (presentation time stamp) of the first I picture of the succeeding VOBU.

4. An audio/video reproduction apparatus according to claim 1,
wherein the stream separation unit further comprises a unit which receives seamless information indicating whether or not the video and audio streams can be connected seamlessly for the MPEG stream having the temporal discontinuity of the video and audio streams and determines whether or not the stream can be seamlessly connected, and
in the case where the stream can be connected seamlessly, the stream is connected seamlessly and in the case where the stream cannot be connected seamlessly, the stream is connected using the stop unit, the change unit and the restart unit.

5. An audio/video reproduction apparatus according to claim 1, further comprising a third storage unit which stores the MPEG stream read from the medium,
wherein the stream separation unit comprises:
a unit which reads the MPEG stream stored in the third storage unit;
a unit which reads the data from the third storage unit and writes the data in the first and second storage units in the subsequent stages until the detection of the head of the succeeding VOBU in the case where the underflow of the third storage unit is detected during the reproduction of the MPEG stream;
a unit which stops the operation of reading the data from the third storage unit and writing data in the first and second storage units in subsequent stages upon detection of the head of the succeeding VOBU, and confirms the accumulation of a predetermined amount of data in the third storage unit and the end of the reproduction of the preceding VOBU written in the first and second storage units; and
a unit which restarts the operation of reading the data from the third storage unit and writing the data in the first and second storage units while at the same time changing the value on the clock unit after complete reproduction of the preceding VOBU.

6. An audio/video reproduction apparatus according to claim 5,
wherein the stream separation unit comprises:
a unit which, upon detection of the underflow of the third storage unit, confirms the accumulation of a predetermined amount of data in the third storage unit and the end of the reproduction of the preceding GOP and the audio data corresponding to the preceding GOP written in the first and second storage units before detection of the head of the succeeding GOP; and
a unit which restarts the operation of reading the data from the third storage unit and writing the data in the first and second storage units and changes the value on the clock unit after the end of the reproduction of the preceding GOP and the audio data corresponding to the preceding GOP.

7. An audio/video reproduction method comprising:
separating a video stream and an audio stream from an MPEG stream read from a medium;
storing the read video stream in a first storage unit;
storing the read audio stream in a second storage unit;
providing reference time of operation using a clock unit;
reading the video stream stored in the first storage unit and reproducing by decoding the video stream using a video decoder based on the value on the clock unit; and
reading the audio stream stored in the second storage unit and reproducing by decoding the audio stream using a audio decoder based on the value on the clock unit;
the stream separating further comprising:
determining the continuity of time stamps between a preceding VOBU (video object unit) and a succeeding VOBU midway of the MPEG stream read from the medium;
stopping the operation of writing the data in the first and second storage units until the end of reproduction of the preceding VOBU stored in the first and second storage units by the video decoder and the audio decoder in the case where the discontinuity of the time stamps is detected;
changing the value on the clock unit; and
restarting the operation of writing the data including and subsequent to the succeeding VOBU in the first and second storage units upon completion of reproduction of the preceding VOBU.
